(19) United States
(12) Patent Application Publication
(10) Pub. No.: US 2007/0226488 A1
(43) Pub. Date: Sep. 27, 2007

(54) SYSTEM AND METHOD FOR PROTECTING DIGITAL FILES

(75) Inventors: BOR-CHUAN LIN, Tu-Cheng (TW); GAO-PENG HU, Shenzhen (CN); JIAN HUANG, Shenzhen (CN); CAI-YANG LUO, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/565,650

(22) Filed: Dec. 1, 2006

(30) Foreign Application Priority Data
Mar. 22, 2006 (CN) 200610060014.8

(51) Int. Cl. H04L 9/32; H04L 9/00; G06F 17/30; G06F 7/04; G06K 9/00; H03M 1/68; H04K 1/00; H04N 7/16

(52) U.S. Cl. 713/156; 713/173; 713/175; 726/27; 713/165; 713/167

(57) ABSTRACT

A system for protecting digital files is provided. The system includes at least one client computer and a server connected to the at lease one server. Each client computer includes: a file identifier generating module, for generating a file identifier for a digital file; a key generating module, for generating a key for the digital file; and a data encoding module, for encrypting the digital file according to the key. The server includes an identification validating module for determining whether a user intending to access the digital file has a corresponding access right, according to the user's digital certificate information. A related method is also provided.

### BACKGROUND OF THE INVENTION

1. Field of the Invention

The present invention generally relates to a system and method for protecting digital files.

2. Description of Related Art

Digital rights management (DRM) technologies help protect the copyrights of digital file owners by, in general, restricting access to their digital files. The digital files typically include electronic documents, images, graphs, music, movies, and so on. Conventionally, DRM technologies focus on preventing those without permission to access the digital files. Specifically, only those with legal permission are permitted to access the digital files.

A typical drawback of the above conventional method is that, when a person with legal permission accesses a digital file and intentionally distributes it to a third party, the third party would be able to access the digital file without legal permission, and the digital file can be illegally copied, reused, processed, and further distributed.

What is needed, therefore, is a mechanism for flexibly and efficiently protecting digital files.

### SUMMARY OF THE INVENTION

A system for protecting digital files according to a preferred embodiment is provided. The system includes at least one client computer and a server connected to the at least one client computer. Each client computer includes: a file identifier generating module, for generating a file identifier for a digital file; a key generating module, for generating a key for the digital file; and a data encoding module, for encrypting the digital file according to the key. The server includes an identification validating module for determining whether a user intending to access the digital file has a corresponding access right, according to digital certificate information of the user.

Another embodiment provides a preferred method for protecting digital files. The method includes the steps of: the steps of: (a) creating a digital file; (b) generating a file identifier for the digital file; (c) generating a key for the digital file; (d) encrypting the digital file according to the key; (e) searching for an access right of a user intending to access the digital file; (f) determining whether the user has a corresponding access right according to digital certificate information of the user; and (g) providing the user with the key of the digital file and allowing the user to access the digital file, if the user has a corresponding access right.

Other advantages and novel features of the embodiments will be drawn from the following detailed description with reference to the attached drawings.

### BRIEF DESCRIPTION OF THE DRAWINGS

FIG. 1 is a schematic diagram illustrating a system for protecting digital files according to a preferred embodiment;

FIG. 2 is a block diagram illustrating the system in FIG. 1;

FIG. 3 is a data flow diagram illustrating a preferred method for protecting digital files;

FIG. 4 is a flowchart of the preferred method for protecting digital files; and

FIG. 5 is a detailed description of one step in FIG. 4, namely searching for an access right of a user intending to operate the digital file.

### DETAILED DESCRIPTION OF THE INVENTION

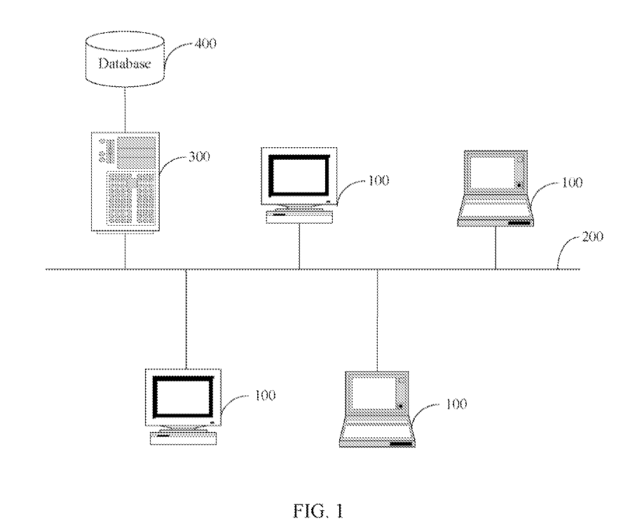

FIG. 1 is a schematic diagram illustrating a system for protecting digital files. The system includes a plurality of distributed client computers 100, a network 200, a DRM server 300, and a database 400. The client computers 100 are connected to the DRM system 300 via the network 200. The network 200 may be an intranet of an enterprise applying/adopting the system, or any other kind of network.

The DRM server 300 is used for receiving an encrypted digital file and the key of the encrypted digital file from the client computer 100, and managing users' access rights to the encrypted digital file.

The database 400 may be implemented as a part of the DRM server 300 system, or an external database of the DRM server 300. The database 400 is used for storing data used or generated by utilizing the system. Such data may include information of each employee of the enterprise, such as a name, an employee ID, a department, title/position, and so on.

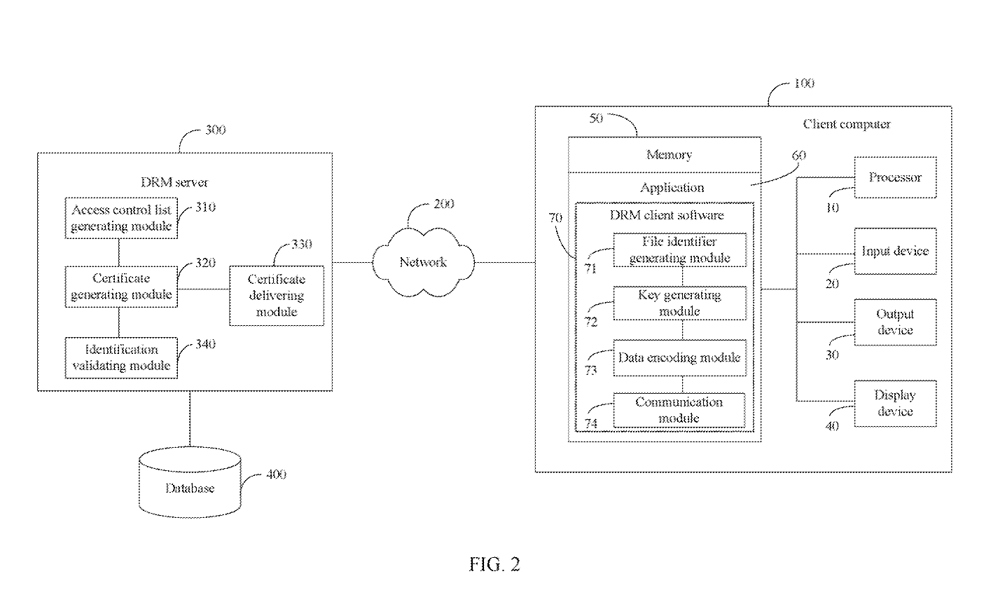

FIG. 2 is a block diagram illustrating the system in FIG. 1. The client computer 100 typically includes a processor 10, an input device 20, an output device 30, a display device 40, and a memory 50. The input device 20 can be any suitable device for entering information into the client computer 100, such as a keyboard, a mouse, a digital camera, a video recorder, and so on. The output device 30 can be a printer or any other type of output device. The display device 40 is for presenting visual information, such as a flat-screen monitor. The memory 50 can be a random access memory (RAM) or a similar type of memory, and may store one or more applications 60, including DRM client software 70 executed by the processor 10.

The DRM client software 70 mainly includes a file identifier generating module 71, a key generating module 72, a data encoding module 73, and a communication module 74.

The file identifier generating module 71 is used for generating a file identifier for the digital file created on the client computer 2. The file identifier is similar to the international standard book number (ISBN) for uniquely identifying the digital file. The file identifier is the same for duplicates of the digital file. For example, if a music file named “a” with a file identifier “Cl-123” stored in a computer A is copied to a second computer B with a file name “a1” and to a third computer C with a file name “a2,” the files “a,” “a1,” and “a2” all have the same file identifier “Cl-123,” even though the file names are different.

The key generating module 72 is used for generating a key for encrypting the digital file.

The data encoding module 73 is used for encrypting the digital file according to the key, and for decrypting the encrypted digital file according to the key.

The communication module 74 is used for sending the encrypted digital file and the key of the digital file to the DRM server 300. Additionally, the communication module 74 is used for notifying the DRM server 300 to validate each user's access right whenever the encrypted file is being accessed in the DRM server 300.

The DRM server 300 includes an access control list generating module 310, a certificate generating module 320, a certificate delivering module 330, and an identification validating module 340.

The access control list (ACL) generating module 310 is used for generating an ACL for the encrypted digital file based on the employee information stored in the database 400. The ACL specifies access rights corresponding to different users of the enterprise to the encrypted digital file. The access rights typically include reading, downloading, printing, and/or editing the electronic file.

The certificate generating module 320 is used for generating a digital certificate for each user based on the ACL.

The certificate delivering module 330 is used for delivering the digital certificate to a corresponding user.

The identification validating module 340 is used for determining whether the user accessing the digital file has the corresponding access right based on the user's digital certificate information and the ACL.

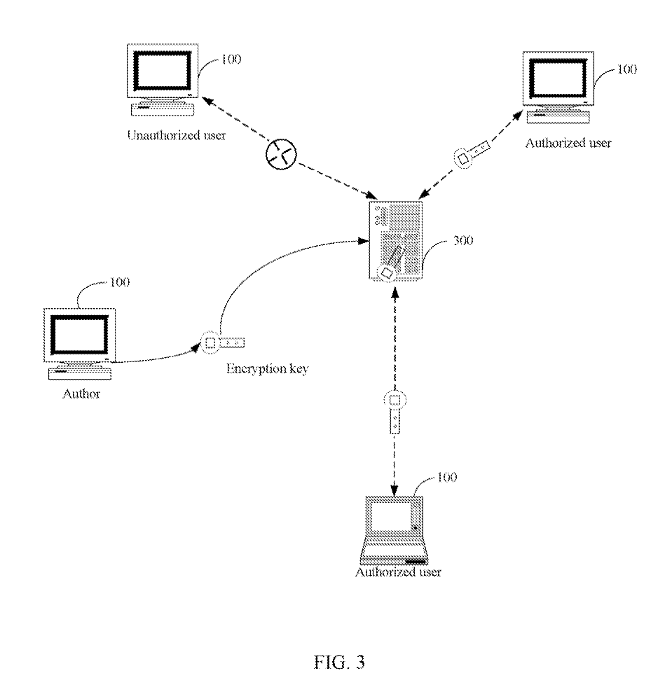

FIG. 3 is a data flow diagram illustrating a preferred method for protecting digital files. Firstly, the file author creates a digital file at a client computer 100, then the file author invokes the DRM client software 70 to encrypt the digital file and delivers the encrypted digital file with the key of the encrypted digital file to the DRM server 300 via the network 20. The DRM server 300 creates the ACL of the encrypted digital file, and provides a digital certificate to each authorized user based on the ACL correspondingly. When another user (not the file author) at another client computer 100 requests to access the encrypted digital file, the DRM server 300 detects whether the user has the corresponding access right based on the digital certificate of the user correspondingly. If the user has the corresponding access right to the encrypted digital file, the DRM server 300 provides the user with the key of the encrypted digital file correspondingly. Otherwise, if the DRM server 300 detects the user is an unauthorized user, the DRM server 300 refuses to provide the key to the user.

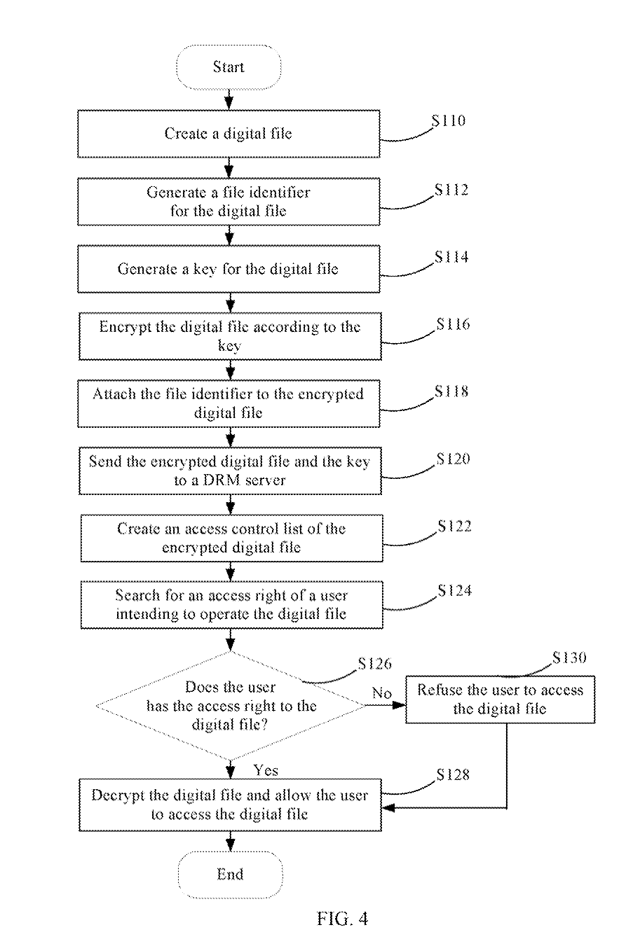

FIG. 4 is a flowchart of a preferred method for protecting digital files by utilizing the system of FIG. 2. In step S110, the file author (e.g. an engineer in an enterprise) creates the digital file (e.g. an electronic file) via the input device 20. In step S112, the file identifier generating module 71 generates the file identifier of the digital file similar to the ISBN for identifying the digital file. In step S114, the key generating module 72 generates the key for the digital file. In step S116, the data encoding module 73 creates the encrypted digital file by encrypting the digital file according to the key. In step S118, the file identifier generating module 71 attaches the file identifier to the encrypted digital file. In step S120, the communication module 74 sends the encrypted digital file and the key of the digital file to the DRM server 300.

In step S122, the access control list generating module 310 generates the ACL of the encrypted digital file based on the file identifier of the encrypted digital file and the employee information of the enterprise. The ACL specifies access rights of different employees of the enterprise to the encrypted digital file.

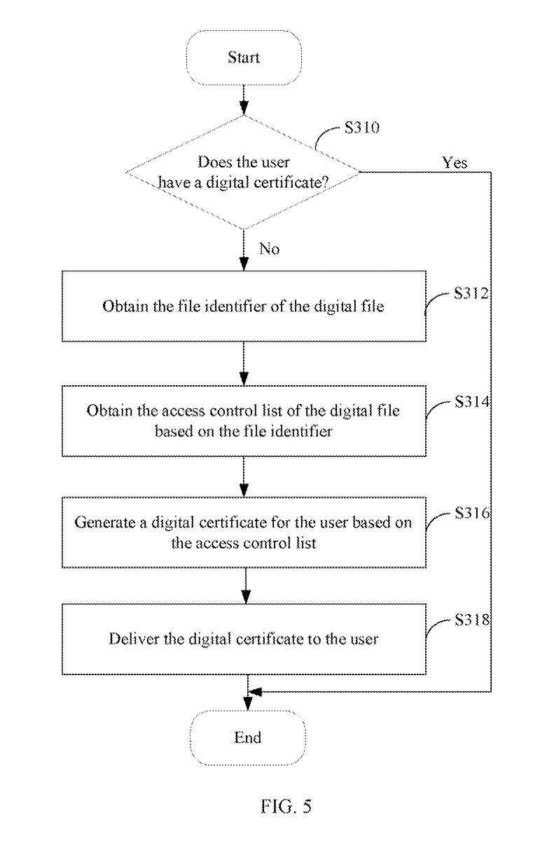

In step S124, when another user (may be not the engineer) at a client computer 100 requests to access the digital file, the identification validating module 340 searches for the access right of the user (detailed description is given in FIG. 5). In step S126, the identification validating module 340 determines whether the another user has the access right according to digital certificate information of the another user.

If the employee has the access right (e.g. reading the electronic file), in step S128, the identification validating module 340 provides the employee with the key of the digital file key and allows the employee to read the digital file. For example, if the identification validating module 340 detects that the employee only has the READ access rights of the digital file is limited to reading, the user is only able to decrypt the encrypted digital file for reading with the key. However, when the user intends to perform other privileges on the electronic file, such as transmitting the electronic file, the communication module 74 notifies the DRM server 300, and the identification validating module 340 denies the user.

Otherwise, if the user has no access rights, in step S130, the identification validating module 340 refuses the employee to access the digital file.

FIG. 5 is a detailed description of step S124 in FIG. 4. In step S310, the identification validating module 340 detects whether the user has the digital certificate. If the user has the digital certificate, the procedure goes to step S126 described above.

Otherwise, if the user does not have the digital certificate for the encrypted digital file, in step S312, the identification validating module 340 obtains the file identifier of the encrypted digital file.

In step S314, the identification validating module 340 obtains the ACL of the encrypted digital file based on the file identifier. In step S316, the certificate generating module 320 generates the digital certificate of the user according to the ACL. In step S318, the certificate delivering module delivers the digital certificate to the user, and the procedure goes to step S126.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for protecting digital files, comprising at least one client computer, the at least one client computer comprising:
a file identifier generating module for generating a file identifier for a digital file;
a key generating module for generating a key for the digital file; and
a data encoding module for encrypting the digital file according to the key; and
a server connected to the at least one client computer, the server comprising:
an identification validating module for determining whether a user intending to access the digital file has a corresponding access right, according to digital certificate information of the user.

2. The system as claimed in claim 1, wherein the server further comprises:
an access control list generating module for generating an access control list of the digital file based on the file identifier, the access control list specifying access rights of different users to the digital file;
a certificate generating module for generating a digital certificate for each user based on the access control list; and
a certificate delivering module for delivering each digital certificate to a corresponding user.

3. The system as claimed in claim 1, wherein the file identifier generating module is further used for attaching the file identifier to the encrypted digital file.

4. The system as claimed in claim 1, wherein the data encoding module is further used for decrypting the encrypted digital file with the key, when the user intending to access the digital file has the corresponding access right.

5. The system as claimed in claim 1, wherein the identification validating module is further used for refusing the user to access the digital file, if the user does not have the corresponding access right to the digital file.

6. A computer-based method for protecting digital files, comprising the steps of:
creating a digital file;
generating a file identifier for the digital file;
generating a key for the digital file;
encrypting the digital file according to the key;
searching for an access right of a user intending to access the digital file;
determining whether the user has the corresponding access right according to digital certificate information of the user; and
providing the user with the key of the digital file and allowing the user to access the digital file, if the user has the corresponding access right.

7. The method as claimed in claim 6, wherein the encrypting step comprises the step of:
attaching the file identifier to the encrypted digital file.

8. The method as claimed in claim 7, wherein the searching step comprises the steps of:
determining whether the user has a digital certificate;
obtaining the file identifier of the encrypted digital file, if the user has no digital certificate;
obtaining an access control list of the encrypted digital file based on the file identifier;
generating the digital certificate for the user according to the authority list; and
delivering the digital certificate to the user.

9. The method as claimed in claim 6, further comprising the step of:
refusing the user to access the digital file, if the user has no corresponding access right.
